(19) United States
(12) Patent Application Publication
(10) Pub. No.: US 2024/0237686 A1
(43) Pub. Date: Jul. 18, 2024

(54) METHOD OF PREPARING A HIGH FIBER, PHASE STABLE LIQUID FROM FOOD MANUFACTURING SIDE STREAM MATERIAL

(71) Applicant: SOCIETE DES PRODUITS NESTLE S.A., Vevey (CH)

(72) Inventors: YU-JIE WANG, Lausanne (CH); LISA MARCELA LAMOTHE, Lausanne 26 (CH); SYLVIE JOELLE MERINAT, Venthone (CH)

(21) Appl. No.: 18/044,671

(22) PCT Filed: Sep. 10, 2021
(86) PCT No.: PCT/EP2021/074938

§ 371 Date: Mar. 9, 2023

(30) Foreign Application Priority Data
Sep. 11, 2020 (EP) 20195698.4

(51) Int. Cl. A23L 19/00; A23C 11/00; A23G 9/42; A23L 2/52; A23L 7/10; A23L 11/00

(52) U.S. Cl. CPC A23L 19/09; A23C 11/00; A23G 9/42; A23L 2/52; A23L 7/115; A23L 11/05

(57) ABSTRACT

The present invention relates to a method of preparing a high fiber, phase stable liquid, said method comprising preparing a slurry comprising between 0.5 to 20 wt % plant material, said plant material comprising at least 30 wt % fiber on a dry matter basis, wherein the fiber comprises at least 60 wt % insoluble fiber on a dry matter basis; and homogenizing the slurry whilst simultaneously subjecting the slurry to a pressure of between 200 to 2000 bar.

### CROSS REFERENCE TO RELATED APPLICATIONS

The present application is a National Stage of International Application No. PCT/EP2021/074938, filed on Sep. 10, 2021, which claims priority to European Patent Application No. 20195698.4, filed on Sep. 11, 2020, the entire contents of which are being incorporated herein by reference.

### INTRODUCTION

Fiber enrichment of liquid products is challenging even when the fibers used are largely soluble fibers. Although they don't tend to phase separate, they are still viscous when used at the high concentrations required for many fiber related health claims on product labels. This brings processing challenges and ultimately poor flowability of final products. It is common to hydrolyze the soluble or insoluble fibers with enzymes or chemicals into smaller molecules producing lower viscosity, however this is not sustainable would not be regarded as clean-label in most cases.

Side stream materials derived from food manufacturing processes are potentially nutritious due to their high content of fiber, protein and phytochemicals. Examples include cereal brans, spent grains or coffee grounds, hulls of legumes, and residue from soy milk production known as okara. Side stream fibers and proteins are mostly insoluble, which limits their functionality in many applications especially for liquid applications such as beverages. The insoluble particles sediment in liquid continuous phase, causing phase separation.

### SUMMARY OF THE INVENTION

The inventors have discovered that high-pressure homogenization of certain hydrated side stream materials can be used to provide a high fiber, phase stable liquid.

In a first aspect, the invention relates to a method of preparing an edible high fiber, phase stable liquid, said method comprising homogenizing a slurry comprising plant based material whilst simultaneously subjecting the slurry to a pressure greater than 100 bar.

In a second aspect, the invention relates to an edible high fiber, phase stable liquid made by a method as described herein.

In a third aspect, the invention relates to the use of high pressure homogenization to prepare an edible high fiber, phase stable liquid.

### EMBODIMENTS OF THE INVENTION

The invention relates in general to a method of preparing an edible high fiber, phase stable liquid, said method comprising
a. preparing a slurry comprising plant material, said plant material comprising fiber, wherein the fiber comprises insoluble fiber; and
b. homogenizing the slurry whilst simultaneously subjecting the slurry to a pressure greater than 100 bar.

In particular, the invention relates to a method of preparing an edible high fiber, phase stable liquid, said method comprising
a. preparing a slurry comprising between 0.5 to 20 wt % plant material, said plant material comprising at least 30 wt % fiber on a dry matter basis, wherein the fiber comprises at least 60 wt % insoluble fiber; and
b. homogenizing the slurry whilst simultaneously subjecting the slurry to a pressure of between 200 to 2000 bar.

In some embodiments, in step b), the slurry is microfluidized whilst simultaneously subjecting the slurry to a pressure of between 200 to 2000 bar.

In some embodiments, the slurry is derived from an industrial food process.

In some embodiments, the slurry comprises between 2 to 15 wt % plant material.

In some embodiments, said plant material comprises between 30-75 wt % fiber on a dry matter basis.

In some embodiments, the fiber comprises between 60 to 95 wt % insoluble fiber, or at least 70 wt %, or between 70 to 90% insoluble fiber.

In some embodiments, the plant material is derived from one or more of cocoa, pea, barley spent grain, okara, rice, and oat.

In some embodiments, the plant material is derived from one or more of cocoa shell fiber, pea hull fiber, pea endosperm fiber, rice bran, oat bran, or oat residue from oat beta-glucan extraction.

In some embodiments, the plant material is derived from cocoa, particularly cocoa shell fiber.

In some embodiments, the slurry comprises between 2 to 20 wt % cocoa shell fiber, preferably 10 to 20 wt % cocoa shell fiber, preferably about 15 wt % cocoa shell fiber.

In some embodiments, step b) is repeated at least once.

In some embodiments, step b) is repeated at least once and the slurry is subjected to a pressure of between 300 to 800 bar, preferably between 450 to 750 bar.

The invention further relates to a high fiber, phase stable liquid made by a method as described herein.

In some embodiments, the liquid comprises plant material derived from one or more of cocoa, pea, barley spent grain, okara, rice, and oat.

In some embodiments, the plant material is derived from one or more of cocoa shell fiber, pea hull fiber, pea endosperm fiber, rice bran, oat bran, or oat residue from oat beta-glucan extraction.

In some embodiments, the liquid has a fiber content of at least 6 g per 100 ml.

In some embodiments, the liquid has a viscosity of at least 35 mPa·s.

A phase stable liquid is defined as one having a high volume fraction, i.e. at least 50% (v/v).

In some embodiments, the liquid has a volume fraction of at least 50% (v/v).

In some embodiments, the liquid has a volume fraction of at least 70% (v/v).

In some embodiments, the liquid has a volume fraction of at least 90% (v/v).

In some embodiments, the liquid has a volume fraction of about 100% (v/v).

In some embodiments, the liquid is devoid of additives.

In some embodiments, the liquid comprises cocoa fiber and has a volume fraction of between 80 to 100% (v/v).

In some embodiments, the liquid comprises pea hull fiber and has a volume fraction of between 50 to 100% (v/v).

In some embodiments, the liquid comprises pea endosperm fiber and has a volume fraction of between 70 to 90% (v/v).

In some embodiments, the liquid comprises spent barley grain and has a volume fraction of between 50 to 55% (v/v).

The invention further relates to the use of high pressure homogenization to prepare a high fiber, phase stable liquid, wherein said liquid has a fiber content of at least 1.5 g per 100 ml, or at least 3 g per 100 ml, or at least 6 g per 100 ml.

In some embodiments, the liquid comprises plant material derived from one or more of cocoa, pea, barley spent grain, okara, rice, and oat.

In some embodiments, the plant material is derived from one or more of cocoa shell fiber, pea hull fiber, pea endosperm fiber, rice bran, oat bran, or oat residue from oat beta-glucan extraction.

In some embodiments, the liquid has a fiber content of at least 6 g per 100 ml. In some embodiments, the liquid has a viscosity of at least 35 mPa·s.

A phase stable liquid is defined as one having a high volume fraction, i.e. at least 50% (v/v).

In some embodiments, the liquid has a volume fraction of at least 50% (v/v). In some embodiments, the liquid has a volume fraction of at least 70% (v/v). In some embodiments, the liquid has a volume fraction of at least 90% (v/v). In some embodiments, the liquid has a volume fraction of about 100% (v/v).

In some embodiments, the liquid is devoid of additives.

In some embodiments, the liquid comprises cocoa fiber and has a volume fraction of between 80 to 100% (v/v).

In some embodiments, the liquid comprises pea hull fiber and has a volume fraction of between 50 to 100% (v/v).

In some embodiments, the liquid comprises pea endosperm fiber and has a volume fraction of between 70 to 90% (v/v).

In some embodiments, the liquid comprises spent barley grain and has a volume fraction of between 50 to 55% (v/v).

In some embodiments, the high fibre, phase stable liquid is a thickener, stabilizer, emulsifier, or fat replacer.

In some embodiments, the liquid can be made into a culinary cream. Preferably, the culinary cream is low fat. Preferably, the culinary cream has no stabilizers.

In some embodiments, the liquid can be made into a smoothie. Preferably, the smoothie has no additives.

In some embodiments, the liquid can be made into a milk alternative.

In some embodiments, the liquid can be made into ice cream. Preferably, the ice cream is low fat.

### DETAILED DESCRIPTION

The invention relates to a method of preparing a high fiber, phase stable liquid, said method comprising
a. preparing a slurry comprising between 0.5 to 20 wt % cocoa fiber, said cocoa fiber comprising between 45-65 wt % fiber on a dry matter basis, wherein the fiber comprises between 60-85 wt % insoluble fiber; and
b. homogenizing the slurry whilst simultaneously subjecting the slurry to a pressure of at least 300 bar, preferably between 500 to 700 bar.

The cocoa fiber may comprise about 55 wt % fiber on a dry matter basis. The fiber may comprise about 72 wt % insoluble fiber.

The invention further relates to a method of preparing a high fiber, phase stable liquid, said method comprising
a. preparing a slurry comprising between 0.5 to 20 wt % pea hull fiber, said pea hull fiber comprising between 50-70 wt % fiber on a dry matter basis, wherein the fiber comprises at least 85 wt % insoluble fiber; and
b. homogenizing the slurry whilst simultaneously subjecting the slurry to a pressure of at least 200 bar, preferably about 700 bar.

The pea hull fiber may comprise about 65 wt % fiber on a dry matter basis. The fiber may comprise about 94 wt % insoluble fiber.

The invention further relates to a method of preparing a high fiber, phase stable liquid, said method comprising
a. preparing a slurry comprising between 0.5 to 20 wt % okara, said okara comprising between 30-55 wt % fiber on a dry matter basis, wherein the fiber comprises at least 75 wt % insoluble fiber; and
b. homogenizing the slurry whilst simultaneously subjecting the slurry to a pressure of at least 200 bar, preferably about 700 bar.

The okara may comprise about 42 wt % fiber on a dry matter basis. The fiber may comprise about 87 wt % insoluble fiber.

The invention relates to a method of preparing a high fiber, phase stable liquid, said method comprising
a. preparing a slurry comprising between 0.5 to 20 wt % barley spent grain, said barley spent grain comprising between 40-65 wt % fiber on a dry matter basis, wherein the fiber comprises at least 90 wt % insoluble fiber; and
b. homogenizing the slurry whilst simultaneously subjecting the slurry to a pressure of between 200 to 2000 bar, preferably between 700 to 1000 bar.

The barley spent grain may comprise about 52 wt % fiber on a dry matter basis. The fiber may comprise about 92 wt % insoluble fiber.

The term “homogenization” refers to a process that produces a homogeneous size distribution of particles suspended in a liquid. Homogenizers are typically able to process fluid matrices at pressure ranging between 200 to 1000 bar. Nowadays, they are employed in the dairy, beverage, pharmaceutical, and cosmetic industries mainly to reduce particle size and consequently increase stability of emulsions in order to avoid creaming and coalescence phenomena.

A homogenizer typically comprises a pump and a homogenizing valve. The pump is used to force the fluid into the valve which acts as the site of the homogenization. In the homogenizing valve the fluid is typically forced under pressure through a small orifice between the valve and the valve seat. The operating pressure can be controlled by adjusting the distance between the valve and the seat.

High Pressure Homogenization (HPH) is typically performed by forcing a liquid through a narrow nozzle at high pressure, thereby establishing high shear stress. Typically in the art, the pressures used are moderate (between 15 and 40 bars). This can be used to stabilize bio-oil as emulsions, and the droplet size can be adjusted by the levels of pressure and energy input, but not enough for processing of insoluble fibers Microfluidization is a form of homogenization. As referred to herein, microfluidization is a combined processing mechanism of hydro-dynamic cavitation, intense shear rates, ultrahigh pressure and instantaneous pressure drop, high-velocity impact forces and high-frequency vibration with a short treatment time. A microfluidizer typically contains a reaction chamber in which the fluid flows in a channel is forced to divide into two or more microstreams when extremely high levels of shear stress and turbulence are induced. Thus, the microstreams are mixed by colliding with each other at very high speeds up to 400 m/see and with the wall surface that resulted in the formation of fine emulsions/fine particle distribution. Then, the product is effectively cooled and can be collected in the output reservoir. Because of instantaneous pressure drop at the exit of the interaction chamber, fluid subjected to microfluidization process is expanded resulting in loosening of the tightly packed architecture of the particles and thus pores or cavitation are formed inside fluid.

Side stream materials can be wet or dry based on availability. Typically, they are hydrated in water for about an hour before high pressure homogenization. Typically, the particle size of the side stream is smaller than the valve of the homogenizer.

The side stream materials may have about the same fiber % content and about same monosaccharide composition in mol % as the corresponding materials shown in Tables 1 and 2.

Cocoa shell fiber (from Cocoa shells) are the main by-product of cocoa, separated from the cotyledons during the pre-roasting process or after the roasting process. Cocoa shells are collected, dried and milled. Sometimes they are alkali treated to remove heavy metals before drying and milling.

Okara is the insoluble residue of soy milk or tofu production. It is wet and can be dried into powder.

Pea hull fiber is produced from the dehulling process of pea. The hulls are typically milled. Pea fiber from endosperm is produced by physical separation from pea flours.

Barley spent grain is produced in malt or beer production after malting and mashing. It is the insoluble part obtained after filtration.

Wheat bran is produced as a side product of milling of wheat into white flour. Wheat is usually milled by roller milling, which delivers multiple product streams including bran.

The liquid may be devoid of additives, for example gums.

As used herein, “about” is understood to refer to numbers in a range of numerals, for example the range of −30% to +30% of the referenced number, or −20% to +20% of the referenced number, or −10% to +10% of the referenced number, or −5% to +5% of the referenced number, or −1% to +1% of the referenced number. All numerical ranges herein should be understood to include all integers, whole or fractions, within the range. Moreover, these numerical ranges should be construed as providing support for a claim directed to any number or subset of numbers in that range. For example, a disclosure of from 45 to 55 should be construed as supporting a range of from 46 to 54, from 48 to 52, from 49 to 51, from 49.5 to 50.5, and so forth.

### EXAMPLES

### Example 1

### Impact of Fiber Source

Side stream materials (pea fiber, cocoa fiber, wheat bran, barley spent grain) mainly composed of insoluble fibers and insoluble proteins were selected. Two different pea fibers (Pea Vitacel from hull & Pea Swelite from endosperm) were selected to compare the fibers from different locations of pea. Fiber type and composition are shown in Table 1 (as used below and elsewhere, LMW=low molecular weight, and HMW=high molecular weight).

TABLE 1

| | Fiber % | | | | | | | |
|---|---|---|---|---|---|---|---|---|
| | | | LMW | HMW | Total | | | |
| | | | fiber | soluble | dietary | Protein | Ash | Starch |
| Sample | Insoluble | Soluble | soluble | fiber | fiber | % | % | % |
| Pea fiber | 62.1 | 4.4 | 2.2 | 2.2 | 66.6 | 10 | 2.5 | 3 |
| Vitacel | | | | | | | | |
| Okara | 37.4 | 5.4 | 2.6 | 2.8 | 42.8 | >20 | | |
| Cocoa fiber | 40.4 | 14.8 | 0.5 | 14.3 | 55.2 | 16 | 13.3 | |
| Wheat bran | 39.5 | 9.5 | 3.2 | 6.4 | 49.1 | 19 | | 11 |
| Barley spent | 48.2 | 4.4 | 0.8 | 3.6 | 52.6 | 19 | 3.2 | |
| grain | | | | | | | | |
| Pea fiber | 46.3 | 8.5 | 6.7 | 1.8 | 54.8 | 4 | | 38 |
| Swelite | | | | | | | | |

Table 2 below shows the monosaccharide composition and lignin content of the side stream materials (Xyl=xylose, Ara=arabinose, Rha=rhamnose, Fuc=fucose, Man=mannose, Gal=galactose, and Glc=glucose.

TABLE 2

| | Monosaccharide composition in mol % | | | | | | | | |
|---|---|---|---|---|---|---|---|---|---|
| | | | | | | | | Uronic | Lignin |
| Fiber name | Xyl | Ara | Rha | Fuc | Man | Gal | Glc | acid | % |
| Pea fiber Swelite | 23.0 | 0.6 | 0.0 | 0.0 | 3.6 | 3.7 | 59.0 | 10.0 | 0.3 |
| Pea fiber Vitacel | 7.8 | 23.6 | 1.0 | 0.0 | 0.4 | 4.1 | 51.8 | 11.4 | 0.2 |
| Okara | 7.0 | 15.8 | 1.7 | 2.4 | 3.3 | 30.2 | 27.5 | 12.2 | 0.7 |
| Cocoa fiber | 5.4 | 5.9 | 2.8 | 0.0 | 7.8 | 8.8 | 42.7 | 26.7 | 34.3 |
| Barley spent grain | | | | | | | | | 2.6 |
| Wheat bran | 44.4 | 24 | 0 | | 0.9 | 2.0 | 24.7 | 8.4 | 8.4 |

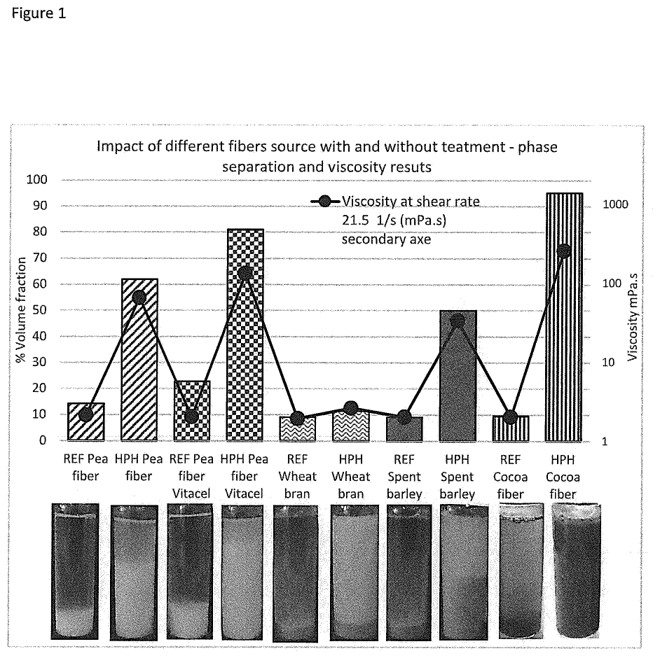

As shown in FIG. 1, all fibers treated by high pressure homogenization (HPH) had an increase in volume fraction in suspension, except for wheat bran. The effect varied depending on the fiber source. This increase in volume fraction and the phase stability corresponded to the increase of viscosity. Cocoa fiber suspension was the most stable one and it had the highest viscosity as well. Wheat bran had limited fiber expansion and viscosity increase after HPH treatment at 700 bar which explained its instability in suspension. Higher pressures might work better for wheat bran but this was not tested. The volume fraction of spent barley increased 5 times after HPH treatment. Both pea inner (endosperm) fiber and pea fiber from hulls showed a considerable increase in viscosity and volume fraction, and the effect of pea hull (Vitacel) was more considerable because it has higher fiber fraction and lower starch fraction compared to pea inner fiber. Green banana flour which is high in resistant starch was also tested, but HPH did not improve its suspension stability or viscosity.

These fibers have a big expansion which contributed to the increase in volume, and the viscosity increase was mostly due to the crowding effect of the swollen particles which gave a resistance to flow. This allows to make beverages and liquid formulations without phase separation and high viscosity problem as seen with many soluble fibers.

FIG. 1 shows phase separation after 20 hours and viscosity results of different fibers 3% in water treated and not treated (REF: Reference sample without treatment. HPH: High pressure homogenized).

Under white light, microspcopy showed that high pressure homogenization led to a clear disruption of big particles, which led to a better dispersing of particles. HPH treatment also produced more cloudy clusters which indicated an opening of the structure of the compact particles. Concerning fast green coloration for proteins, the imaging did not show a big difference between treated and untreated samples. It could be concluded that the particles were smaller and well dispersed.

### Example 2

### Impacts of Concentration, Pressure and Pasteurization

Cocoa fiber was selected to study the impact of concentration, pressure and pasteurization on the phase stability of the fiber suspension. Table 3 shows the parameters used for cocoa fiber. Tests were performed to define the impact of concentration, pressure and pasteurization on suspension stability. In table 3, REF means reference sample without high pressure homogenization, HPH means High pressure homogenized samples, and Pasto means Pasteurized samples.

TABLE 3

| | | Concen- | |
|---|---|---|---|
| | | tration in | |
| | | water % | Pressure |
| Impact | Sample name | (w/w) | (bars) |
| Concen- | Cocoa 3% REF | 3 | Not treated |
| tration | Cocoa 3% HPH | 3 | 650-700 |
| | Cocoa 8% REF | 8 | Not treated |
| | Cocoa 8% HPH | 8 | 650-700 |
| | Cocoa 15% REF | 15 | Not treated |
| | Cocoa 15% HPH | 15 | 650-700 |
| Pressure % | Cocoa 3% REF | 3 | Not treated |
| pasteur- | Cocoa 3% REF pasto | 3 | Not treated |
| ization | Cocoa 3% HPH 100 bars | 3 | 100 |
| | Cocoa 3% HPH 100 bars pasto | 3 | 100 |
| | Cocoa 3% HPH 300 bars | 3 | 300 |
| | Cocoa 3% HPH 300 bars pasto | 3 | 300 |
| | Cocoa 3% HPH 500 bars | 3 | 300 |
| | Cocoa 3% HPH 500 bars pasto | 3 | 500 |
| | Cocoa 3% HPH 700 bars | 3 | 700 |
| | Cocoa 3% HPH 700 bars pasto | 3 | 700 |

Impacts of intensity of HPH (pressure and number of passes) and concentration on phase stability during 3-month storage

Table 4 shows the experimental design using cocoa fiber. In the table, 1 pass means that only one pass on the homogenizer Niro was performed, all other samples were homogenized with two passes on the system.

TABLE 4

| | | Concen- | |
|---|---|---|---|
| | | tration in | |
| | | water % | Pressure |
| Impact | Sample name | (w/w) | (bars) |
| Concentration | Cocoa 8% REF | 8 | Not treated |
| | Cocoa 8% HPH | 8 | 500 |
| | Cocoa 3% HPH | 3 | 500 |
| Single pass | Cocoa 8% HPH (1 | 8 | 500 (1 |
| homogenization | pass) | | pass) |

To prepare the samples, fiber was dispersed in water and agitated and hydrated for at least 1 hour before the high-pressure homogenization. Non treated sample was used as a reference. A Homogenizer Panda Plus NS10001L was used. The samples were passed in the system 1 or 2 times at the selected pressure. For the pasteurization step, samples were kept in Schott Duran glass bottles (50 mL) equipped with PBT screw cap. Pasteurization was performed in autoclave Systec DX-100 by following a cycle described in Table 5.

TABLE 5
Cycle

| ParameterName | ParameterValue |
|---|---|
| SterTemp | 85 |
| SterTime | 20 |
| DryTime | 0 |
| Pulses | 9 |
| EndTemp | 80 |
| ExhMode | 5 |
| ErrorCode | 0 |
| Load nu | 388 |
| Program | 9-Steam/Air |

### Analytical Methods

### Phase Separation

The phase separation of fibers in suspension before and after the high pressure homogenization process were measured. Solutions were pooled into a graduated cylinder or similar and left on the bench without movement at room temperature. The volume of the fiber in suspension and total volume was recorded after 2 h, 20 h and 45 h. There were no significant changes until after 20 h, and so the data represented in FIGS. 1, 3 and 5 shows the results after 20 h. Percent (%) volume fraction was calculated by volume of fiber divided by the total volume multiplied per 100. “% Volume fraction 100%” meant that there was no precipitation, and that all fibers stayed in suspension in water without phase separation.

### Storage Stability

After pasteurization samples were placed in a closed incubator (without light) and without movement at 25° C. The volume of the fiber in water and total volume was recorded after 24 h, 48 h, 1 week, 2 weeks, 1 month and 3 months.

### Viscosity Tests

The viscosity of fiber suspensions was measured with Rheometer (Anton paar). The selected geometry was cup (27 ml, CC27-SS) and vane (ST22-4V-40). Fiber suspension was poured into the cup. The temperature of the peltier was 259 C, and the sample were kept at 252 C for 1 min before measurement started. The shear rate was kept at 1 l/s for 1 min and then changed from 1 to 100 l/s in logarithm and reduced from 100 to 1 l/s in the same way. The flow curve was recorded and the viscosity data at shear rate 21.5 l/s was used for comparison of samples.

### Impact of Fiber Concentration

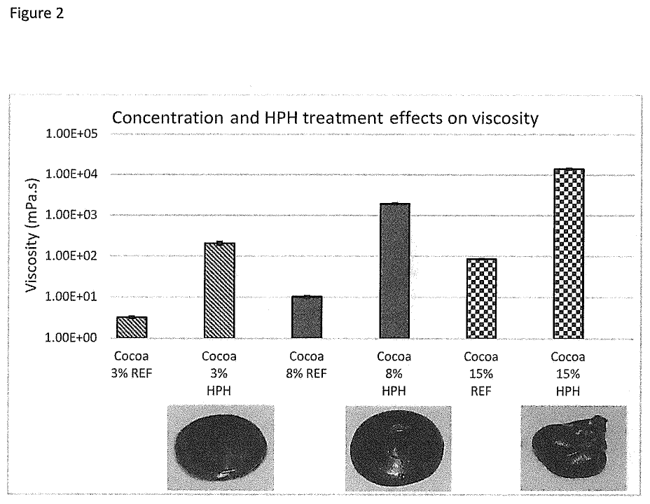

In order to understand the maximum fiber concentration that can be used to pass the high pressure homogenizer, cocoa fiber with concentration up to 15% was tested (as shown in FIG. 2). Higher concentration was not allowed due to the increased viscosity and dry matter which limited the flow through the homogenizer. The higher the concentration, the higher the viscosity. Cocoa at 15% after HPH treatment was like a paste or cream with high viscosity.

The maximum concentration of each fiber needed to be tested accordingly because of the different composition and particle conformation.

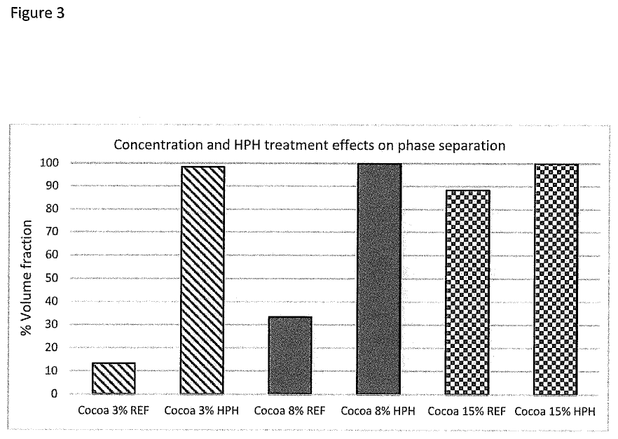

As shown in FIG. 3, HPH treatment affected the phase separation at different concentrations. As the viscosity increases by the increase in fiber concentration, the phase separation reduces. For the cocoa fiber, 3-8% concentration was enough to produce a stable suspension without phase separation. The critical concentration for the fiber to form a stable suspension depends on the fiber source (composition), particle size, viscosity, volume fraction, and the intensity of the treatment, therefore, it needs to be evaluated accordingly. For cocoa fiber, a concentration above 3% was enough to form a stable suspension.

### Impact of Pressure and Pasteurization

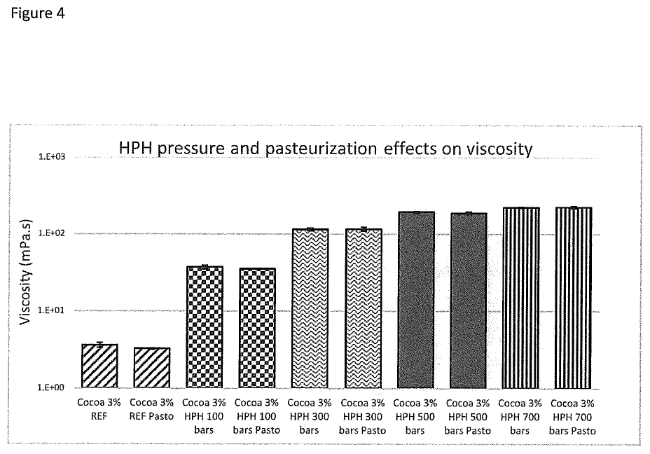

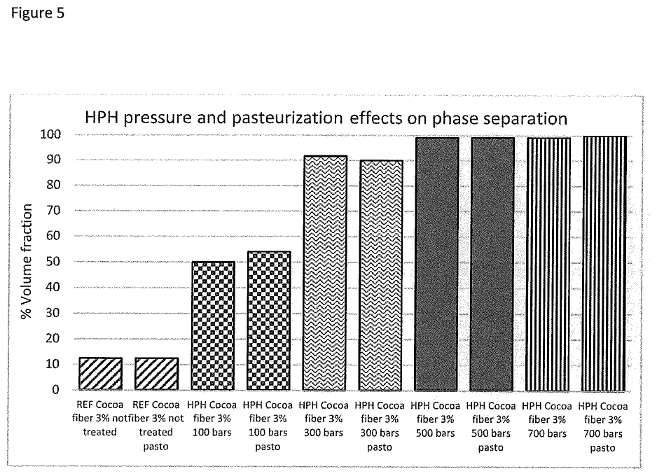

The pressure used in HPH treatment had an impact on viscosity and phase stability of the suspension, as shown in FIGS. 4 and 5. Increasing pressure reduced phase separation and increased the stability of suspension in water. Pressure at 300 bars could already considerably enhance the viscosity and also the phase stability (FIG. 5). As pasteurization is widely used in food miniaturization, the impact of pasteurization on the stability of fiber suspension after HPH treatment was investigated. Results showed that pasteurization of samples did not affect the viscosity and the phase stability.

### Impact of HPH on Phase Stability During 3-Month Storage

The phase stability of the HPH treated fiber suspension was monitored, and as shown in FIG. 6, the suspension was stable for 3 months storage, there was no considerable change on phase separation for both concentrations tested (3% and 8%). A water phase (10% of volume) on top of the suspension with 3% cocoa fiber was observed after 1 week which remained unchanged afterwards. The 8% cocoa fiber did not phase separate and was stable for 3 months.

The impact of number of passes through the homogenizer on the phase stability of fiber suspension was also studied. Fiber suspensions with a single pass were less stable compared to those with 2 passes. There was 5% water phase on top of the suspension of 8% cocoa fiber with a single pass, whereas no phase separation was observed when 2 passes were used.

### Example 3

### Preparation of Emulsions with Side Stream Materials (Cocoa Fiber or Pea Fiber) and Sunflower Oil

The ingredients for recipes 1 to 6 in Table 6 below were weighed out. For all ingredients, a pre-emulsion was formed using a Silverson L5M-A at 7000 rpm for 2 minutes. A pre-emulsion is usually made to produce a coarse suspension or emulsion with large particles or droplets before homogenization in order to produce fine emulsion with smaller particles or droplets. The pre-emulsion was subjected to High Pressure Homogenization (HPH) with homgenizer Panda Plus NS 1000TL. Two passes were done at 700 bars. Pasteurization at 75-80° C. for 15 minutes was performed with a Thermomixer Vorwerk. The resulting product was stored in the fridge.

TABLE 5

| Recipe | 1 | 2 | 3 |
|---|---|---|---|
| Cocoa fiber | 8.1 | 8.0 | |
| Ficoa Moner | | | |
| Pea fiber | | | 8.0 |
| Vitacel EF100 | | | |
| Sunflower oil | 10.0 | 5.0 | 6.0 |
| (high oleic) | | | |
| Vittel water | 81.9 | 87.0 | 86.1 |

A sensory evaluation was performed. The emulsion with cocoa fiber and pea fiber was thick and creamy. They were physically stable and smooth. This can contribute to the removal of stablisers & fat replacers e.g. gums from many products. Higher fat level also contributed to the thickness and creaminess as well. It was possible to create emulsions/suspensions without sunflower oil.

### Example 4

### Preparation of Ice Cream with the Side Stream Materials (Cocoa Fiber or Pea Fiber)

The ingredients for ice cream recipes 1 and 2 in the tables below were weighed out and each were mixed with a spoon, and then mixed for 25 minutes with a Magimix Ice-cream maker. The prepared mixtures were kept in freezer at least one night before tasting.

TABLE 7
(Ice Cream 1)

| Material name | Weight (g) | Conc (%) |
|---|---|---|
| Emulsion 10% pea | 300.00 | 87.3 |
| fiber/3% oil | | |
| | 0.00 | 0.0 |
| Sucrose | 43.00 | 12.5 |
| Orange flavour | 0.7 | 0.2 |
| Burst MSK | | |
| Total | 343.70 | |

TABLE 8
(Ice Cream 2)

| Material name | Weight (g) | Conc (%) |
|---|---|---|
| Emulsion 8% cocoa | 300.00 | 85.7 |
| fiber/10% oil | | |
| | 0.00 | 0.0 |
| Sucrose | 50.00 | 14.3 |
| Chocolate flavour | 0.1 | 0.0 |
| Total | 350.10 | |

TABLE 8
Summary of the composition of ice creams (conc %)

| | Ice Cream 1 | Ice Cream 2 |
|---|---|---|
| | Pea | Cocoa |
| Flavor | Orange | Chocolate |
| Fiber | 6.7 | 4.4 |
| Sugar | 14.3 | 16.7 |
| Sunflower oil | 3.0 | 10.0 |
| Protein | 1.0 | 1.3 |

Emulsions were made using HPH (700 bar, 2 passes). Fiber contents ranging from 3.7% to 6.7% were tested and worked well. Results of sensory evaluation showed that pea fiber gave
a dry mouthfeel which is similar to pea proteins. Cocoa fiber was nicely perceived in terms of mouthfeel and flavor. Since cocoa fiber as such is bitter, higher sugar may be needed. Cocoa fiber with hazelnut flavor was the best combination.

### Example 5

### Preparation of Milk Alternative/Beverages and Culinary Cream with Okara

5% and 10% okara dry powder (Kikkoman, Japan) were hydrated in water for 2 h before homogenization. The suspension was then treated with a high pressure homogenizer (Panda Plus NS 1000TL) at pressure of 700 bar and 2 passes. The treated slurry was heated with Thermomix at 85° C. for 20 min, cooled down and bottled.

The suspension was physically stable. An internal sensory evaluation was performed.

Between 3-5% sugar was added in the recipe before tasting. The slurry with 5% okara was comparable to milk alternative in terms of appearance, viscosity and taste. The taste was soybean-like but mild without perceived off-notes. The slurry with 10% okara was thicker, with creamy mouthfeel. It is judged as good for smoothie and culinary cream application. The 10% okara slurry was cooked in cooking pan as for dairy culinary cream and was found to be stable at high cooking temperature. 5% okara has more than 2% fiber and 10% okara contains more than 4% fiber.

In conclusion, side stream materials are mainly composed of fibers and proteins, however their low water solubility restricts their application in liquids. Mechanical treatment with high pressure homogenization was efficient to functionalize the materials. The treated materials could produce stable suspensions and emulsions without phase separation after long term storage, for example after 3 months at ambient temperature. The critical concentration and pressure needed to produce the stable suspension and emulsion was dependent on fiber source/composition, and particle conformation. The pasteurization process following the high pressure homogenization had no impact on the phase stability.

The impact of high-pressure homogenization on the side stream materials includes particle size reduction, opening of particle structure and swelling, volume fraction increase, viscosity/thickness increase, and protein solubility increase.

High-pressure homogenization could functionalize insoluble fibers and allow the addition of high fiber content (for example over 3 g per 100 ml, preferably 6 g per 100 ml or greater) in drinkable or cream-like products such as breakfast drinks, Nesquik, yoghurt and ice cream. Moreover, it is potential to act as thickener, stabilizer and fat replacer. Without wishing to be bound by theory, it could be that the structure opening of the compact particles by HPH increases the surface area of the insoluble fiber which may increase the availability for the gut microbiota.

1. A method of preparing a high fiber, phase stable liquid,
said method comprising
a. preparing a slurry comprising between 0.5 to 20 wt % plant material, said plant material comprising at least 30 wt % fiber on a dry matter basis, wherein the fiber comprises at least 60 wt % insoluble fiber; and
b. homogenizing the slurry whilst simultaneously subjecting the slurry to a pressure of between 200 to 2000 bar.

2. The method according to claim 1, wherein, in step b), the slurry is microfluidized whilst simultaneously subjecting the slurry to a pressure of between 200 to 2000 bar.

3. The method according to claim 1, wherein the slurry is derived from an industrial food process.

4. The method according to claim 1, wherein the slurry comprises between 2 to 15 wt % plant material.

5. The method according to claim 4, wherein the fiber comprises between 70 to 90 wt % insoluble fiber.

6. The method according to claim 1, wherein the plant material is derived from one or more of cocoa, pea, barley spent grain, and okara.

7. The method according to claim 1, wherein the plant material is derived from one or more of cocoa shell fiber, pea hull fiber, and pea endosperm fiber.

8. The method according to claim 1, wherein the plant material is derived from cocoa shell fiber.

9. The method according to claim 1, wherein step b) is repeated at least once.

10. The method according to claim 1, wherein step b) is repeated at least once and the slurry is subjected to a pressure of between 300 to 800 bar.

11. A high fiber, phase stable liquid made by a method according to claim 1.

12-17. (canceled)
